(19) United States
(12) Patent Application Publication
(10) Pub. No.: US 2025/0251270 A1
(43) Pub. Date: Aug. 7, 2025

(54) APPARATUS, SYSTEM, AND METHOD FOR DETERMINING FLUID LEVEL WITHIN A FLEXIBLE RESERVOIR

(71) Applicant: Mountain Metrics, LLC, Denver, CO (US)

(72) Inventors: Julian Dahl, Denver, CO (US); Jonah Mania, San Francisco, CA (US)

(73) Assignee: Mountain Metrics, LLC, Denver, CO (US)

(21) Appl. No.: 19/047,618

(22) Filed: Feb. 6, 2025

Related U.S. Application Data
(60) Provisional application No. 63/550,336, filed on Feb. 6, 2024.

(51) Int. Cl. G01F 23/292

(52) U.S. Cl. CPC G01F 23/292

(57) ABSTRACT

The present invention is directed to an apparatus, system, and method for the measurement of fluid levels within a reservoir having flexible walls such as found in portable hydration containers, and other instances which benefit from the use of a thin-walled or flexible reservoir.

### FIELD OF THE INVENTION

This application claims benefit to provisional patent application No. 63/550,336, entitled “APPARATUS, SYSTEM, AND METHOD FOR DETERMINING FLUID LEVEL WITHIN A FLEXIBLE RESERVOIR”, filed Feb. 6, 2024, the entire contents of which are incorporated by reference in their entirety for all purposes.

### FIELD OF THE INVENTION

The present invention is directed to an apparatus, system, and method for the measurement of fluid levels within a reservoir having flexible walls such as found in portable hydration containers, and other instances which benefit from the use of a thin-walled or flexible reservoir.

### BACKGROUND OF THE INVENTION

Fluid reservoirs are used for a variety of applications where a fluid needs to be stored for future use. In many applications, it is important to monitor the amount of fluid remaining. Fluid reservoirs are commonly employed for the storage of fuel, water, cleaning solutions, and other such fluids. In some cases, fluid reservoirs comprise a rigid outer envelope, wherein the reservoir comprises a singular shape wherein the reservoir has a permanent form which does not vary. In other cases, however, the fluid reservoir comprises a flexible outer envelope which has a number of benefits.

A flexible outer envelope limits the weight of the reservoir wall material, thereby limiting the weight of the reservoir itself. Furthermore, a flexible outer envelope allows the reservoir to be fit, formed, or stored in a variety of manners limited only by the volume of the fluid held within the reservoir. For instance, a flexible reservoir which has a total volumetric capacity of 2 liters may take up approximately 2 liters of volumetric space when filled with 2 liters of fluid, but only take up approximately 1 liter of volumetric space when filled with 1 liter of fluid, and take up a very limited amount of volumetric space when empty. Further still, a flexible outer envelope requires a thin-walled membrane which results in a substantially lighter weight reservoir than a rigid-walled reservoir with similar capacity.

One particular application of reservoirs with flexible outer envelopes are personal hydration packs such as those disclosed by U.S. Pat. No. 11,432,640 to Garvey, et al. (“Garvey”) and U.S. Pat. No. 7,070,075 to Forsman, et al. (“Forsman”), which are incorporated herein by references for all purposes. Portable personal hydration reservoirs are commonly used during activity such as running, hiking, cycling or other transportation methods for recreation or other transitory purposes. Such hydration packs are worn wherein the reservoir is not readily visible to the user, and as such, a user is not able to accurately observe or track the amount of fluid remaining or consumed thus far.

In addition to the aforementioned problem of monitoring fluid levels within a fluid reservoir, a further challenge with reservoirs comprising a flexible outer envelope is measuring the amount of fluid remaining therein. The flexible nature of the walls results in difficulty in measuring the fluid levels in traditional manners. Therefore, there is an identified need for a novel and useful way to measure the level of remaining fluid held within a reservoir having a flexible outer envelope. It is a further identified need to provide real-time monitoring of water volume during the use of a fluid reservoir with a flexible outer envelope such as found with a personal hydration pack.

### SUMMARY OF THE INVENTION

It is an aspect of the present invention to provide real-time tracking ability of fluid levels remaining within a reservoir, including reservoirs which comprise a flexible outer envelope. While the disclosures set forth are directed toward the monitoring of fluid levels within reservoirs comprising a flexible outer envelope, the embodiments discussed are not limited thereto. The fluid measurement teachings disclosed herein can be used in conjunction with flexible walled reservoirs and rigid walled reservoirs alike.

Existing solutions to the determining and tracking the fluid level within a flexible walled reservoir include those which use flow gauges at the exit of the reservoir, such as a mouthpiece for a hydration pack. Such solutions are problematic as the user is required to recalibrate and reset the system upon refilling to establish the amount of fluid initially within the reservoir. Such systems measure fluid that exits the reservoir, rather than measuring the fluid which remains present.

Other existing solutions, such as found in U.S. Pat. No. 6,990,860 Gillanders (“Gillanders”) which is incorporated herein in its entirety by reference for all purposes, uses magnets in combination with reed switches mounted opposite each other on opposing walls of a flexible walled reservoir. The magnets and reed switches are interconnected to the reservoir in graduated locations wherein when a magnet is in close proximity to a corresponding reed switch, the reed switch is actuated indicating a level below which the fluid is. However, the use of such indirect measurement strategy results in inaccurate readings as the precision of the measurements are heavily dependent upon the number of sensors and the spacing between each paired magnet and reed sensor.

Certain existing solutions, such as U.S. Pat. No. 11,013,353 to Hambrock, et al. (“Hambrock”), incorporated herein in its entirety by reference for all purposes, rely upon infrared emitters and infrared receivers in certain embodiments. The emitters and receivers are paired on opposing sides of the reservoir to transmit across the water column, and thus does not account for the flexible nature of the reservoir for resultant readings. Furthermore, the precision in which the fluid level can be measured with such a configuration is limited to the number of emitters and receivers used and the spacing therebetween. In an alternative embodiment, Hambrock further discloses the use of an ultrasonic emitter directed from the top of the reservoir down toward the bottom of the reservoir, however, the nature of the flexible walled reservoir would result in inconsistent and inaccurate results as the walls of the reservoir would interfere with the lightpath described.

Certain existing solutions, such as U.S. Pat. Nos. 9,322,773 and 9,851,295 to Coates, et al. (“Coates”), incorporated herein in its entirety by reference for all purposes, describe a device for determining relative concentrations of fluids in a sample as well as fluid depth for fluid monitoring systems used in, for example, the heavy equipment, automotive and transportation industries. The device consists of an elongated porous body, an optical emitter positioned at the first end of the elongated body and an optical detector positioned at the second end of the elongated body. The positioning of the optical elements at either end of the elongated body adds unnecessary complication to the design, failing to ensure physical resilience during activity, increasing the burden of electrical and waterproofing design, and reducing the resolution potential of the fluid level detecting aspect of the device by shortening the potential lightpath for absorption to occur.

It is an aspect of the present invention to provide an apparatus, system, and method for the measurement of fluid levels within a reservoir having flexible walls which provides accurate and reliable fluid measurements in reservoirs, particularly those with thin-walled or flexible envelopes, and particularly for use with personal hydration containers.

Certain embodiments of an apparatus for the measurement of fluid levels within a reservoir having flexible walls comprises a fluid reservoir, a reflective assembly, a sensor assembly, and a receiver assembly. In such embodiments, the fluid reservoir is flexible, the emitter is placed adjacent to the interior aspect of a fluid, and the sensor is placed adjacent to an interior aspect of the fluid containment mechanism.

In certain embodiments, the emitter is a light source and light emitted from the light source travels through water and air.

In certain embodiments, the sensor is configured to measure the absorption of light by the water. In certain embodiments, the measurement of the absorption of light within the water allows for measurement of remaining volume of fluid. In certain embodiments, the sensor assembly may be positioned within the fluid reservoir and includes an emitter, a sensor, a sensor circuit board, and a sensor enclosure.

In certain embodiments, the components of the sensor assembly may be made of, but not limited to materials that are FDA approved to come in direct contact with water intended for human consumption.

In certain embodiments, the reflective assembly comprises a reflective material which surrounds the interior aspect of the fluid reservoir. Certain functions of the reflective assembly comprise containing the signal released by the emitter within the container.

In certain embodiments, the receiver assembly interacts directly with the user as well as the sensor circuit board in order to receive a measurement from the sensor assembly, process the received data, and communicate the results to the user.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

A complete understanding of the present invention may be obtained by reference to the accompanying drawing, when considered in conjunction with the subsequent detailed description, in which:

FIG. 1 is a sensor assembly lightpath that shows the lightpath of the emitted signal. The light is generated by the emitter, travels through the volumetric extent of the reflective assembly, which corresponds to the volumetric extent of the container itself, reflects off the reflective assembly back to the interior of the container and encounters the sensor. As the light travels through the lightpath it is absorbed as described in FIG. 5. It will be appreciated by those skilled in the art that the rays drawn in FIG. 1 represent a portion of the lightpath, the real lightpath represents the entire path of the light which diverges from the emitter and reflects within the interior of the reflective assembly. Those rays which are terminated at the sensor are a portion of the total rays generated by the emitter.

FIG. 2 is a sensor enclosure wherein the dimensions represent certain embodiments of the sensor enclosure for both the distal and proximal LED Configurations.

FIG. 3 is a receiver assembly that comprises a receiver enclosure, receiver circuit board, exterior button, and measurement display.

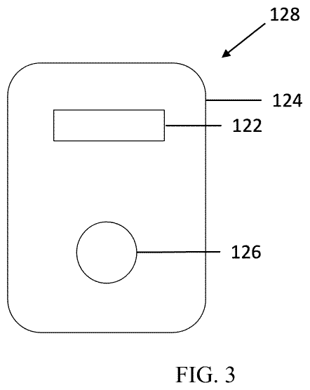

FIG. 4 is a signal flow chart that represents the steps for a user-initiated configuration, which describes the signal path from user measurement initiation to measurement display. This chart specifies how the various components interact operationally in order to complete the overall function of the device, which is to measure the remaining fluid in a collapsible personal hydration container.

FIG. 5 is an absorption formula that describes the means by which the system detects a differential in water fluid level using a battery-generated voltage. Vᵢₙ is produced by a battery operably connected to the sensor circuit board. In certain embodiments, the Vᵢₙ is 1.5V. The emitter converts the Vᵢₙ to Eₘᵢₙ. Eₘᵢₙ is a constant variable in the above formula. In the preferred embodiment, the Eₘᵢₙ is in the form of 940 nm light. Em_{abs} is passively absorbed by the fluid comprising the lightpath between the emitter and the sensor. As the fluid level increases Em_{abs} increases, consequently reducing Emₒᵤₜ. Emₒᵤₜ is received by the sensor and converted into an electric voltage Vₒᵤₜ. Vₒᵤₜ is measured by the sensor circuit board as MDP_{measured} which is transmitted to the receiver circuit board.

FIG. 6 is a remaining fluid formula that describes how the receiver circuit board converts the MDP_{measured}, generated by the sensor assembly, into an estimate of remaining fluid FR.

FIG. 7 is a reflective assembly that represents a certain embodiment of the reflective assembly, which fully encloses the fluid reservoir. In other embodiments, the reflective assembly may be, but is not limited to being positioned within the container, integrated into the walls of the container, or a partial enclosure.

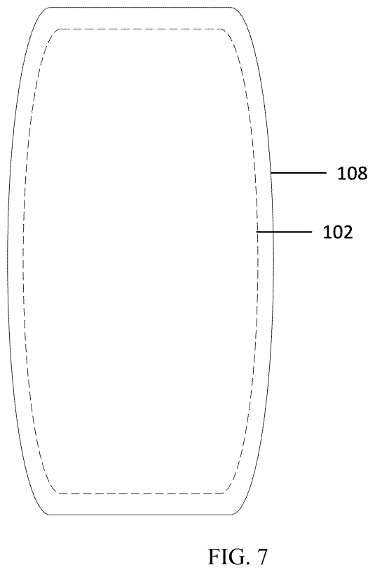

FIG. 8 is a signal flow chart that represents the steps for a predefined frequency configuration, which describes the signal path from measurement initiation to measurement display. This chart specifies how the various components interact operationally in order to complete the overall function of the system, which is to measure the remaining fluid in a container with collapsible walls.

### DETAILED DESCRIPTION

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

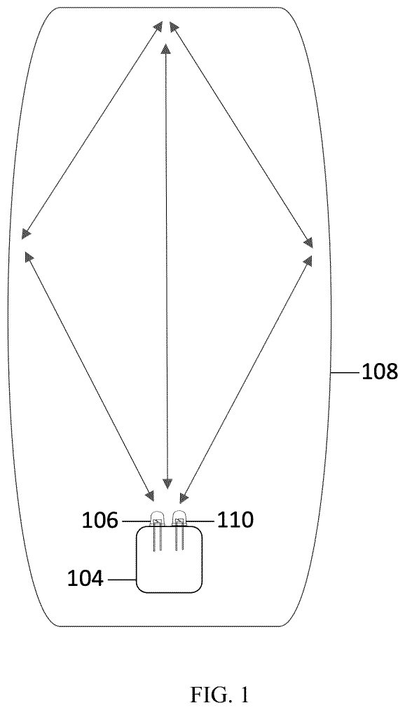

Certain embodiments of an apparatus for the measurement of fluid levels within a reservoir having flexible walls, seen in FIG. 1, comprise a fluid reservoir 102, a reflective assembly 108, a sensor assembly 104, and a receiver assembly 118. In such embodiments, the fluid reservoir 102 may be a thin-walled or flexible walled reservoir. It will be appreciated by those skilled in the art that the embodiments described herein could function the same within a rigid walled reservoir. The emitter 106 is placed adjacent to the interior aspect of a fluid reservoir 102, and the sensor 110 is placed adjacent to an interior aspect of the fluid reservoir 102. In certain embodiments, the emitter 106 and the sensor 110 are placed relative to the bottom interior aspect of the fluid reservoir 102, relative to gravity. In certain embodiments, the emitter 106 is a light source and light emitted from the light source travels through fluid and air. In certain embodiments, the sensor 110 is configured to measure the absorption of light by the fluid. In certain embodiments, the measurement of the absorption of light within the fluid allows for measurement.

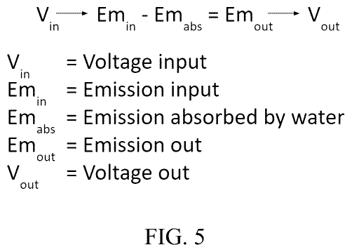

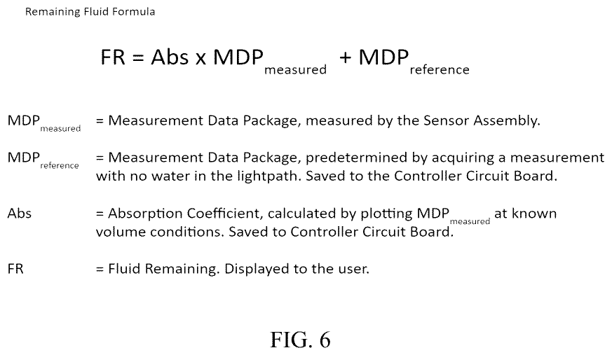

In certain embodiments, the system measures the absorption of light by the fluid in the following manner. A known intensity of light is emitted by the emitter 106, and a portion of that intensity is received by the sensor 110, after traversing through the lightpath, as seen in FIG. 1. The sensor 110 may require a baseline intensity to be calculated, wherein the baseline intensity is calculated with no fluid in the fluid reservoir 102 or is calculated with a known calibration limit. It may be necessary for a baseline intensity received by the sensor 110, as a portion of the total emitted, to be calibrated, by measuring the received intensity without any fluid present; optionally with the reservoir filled with fluid. As more fluid is added to the container, more light intensity is absorbed by the fluid, and thus the sensor 110 receives less intensity, as seen in FIG. 5. Using the intensity measurement from the sensor 110, a volume of fluid present can be calculated using either a known theoretical or developed model based on measured absorption rate, as seen in FIG. 6.

In certain embodiments, the sensor assembly 104 is positioned within the fluid reservoir 102. It will be appreciated by those skilled in the art that the sensor assembly 104 could be positioned on the exterior of the fluid reservoir 102, without losing form or function. Certain functions of the sensor assembly 104 comprise performing the emission and detection of the signal. In certain embodiments, the sensor assembly 104 includes an emitter 106, a sensor 110, a sensor circuit board 112, and a sensor enclosure 120. In certain embodiments, the components of the sensor assembly 104 may be made of materials that are FDA-approved to come in direct contact with water or a fluid intended for human consumption. The materials used for the sensor enclosure 120 may be transmissive to the signal generated by the emitter 106. In certain embodiments, the enclosure is transmissive to the signal generated by the emitter 106, 940 nm light in the preferred embodiment.

In certain embodiments, the reflective assembly 108 comprises a reflective material which surrounds the fluid reservoir 102. Certain functions of the reflective assembly 108 comprise containing the signal released by the emitter 106 within the container. In certain embodiments, the reflective assembly 108 is malleable, and thus able to match the collapsibility of the fluid reservoir 102 itself. In certain embodiments, the reflective assembly 108 may fully or partially enclose the fluid reservoir 102. It will be appreciated by those skilled in the art that the reflective assembly 108 may be located within the interior of the fluid reservoir 102 or may also be located on the exterior of the fluid reservoir 102. In certain embodiments, the reflective assembly 108 may be removable from the container, either from the inside or outside. In other embodiments, the reflective assembly 108 may be manufactured directly into the walls of the container or reservoir.

In certain embodiments, the receiver assembly 118 interacts directly with the user as well as the sensor circuit board 112 in order to receive a measurement from the sensor assembly 104, process the received data, and communicate the results to the user. Certain functions of the receiver assembly 118 comprise interfacing with the user, and using the data collected by the sensor assembly 104 to calculate a fluid level. In certain embodiments, the receiver includes a receiver circuit board 116, a button, a display, and a receiver enclosure 114. In certain embodiments, the receiver assembly 118 is replaced by an application accessible on any smartphone device, or any other user interface, including but not limited to desktop applications, digital screens, and light indicators. In certain embodiments, the receiver may be configured to initiate a measurement resulting from a stimulus from the user. The stimulus from the user may be defined as any action that the user takes to initiate a measurement immediately following that action. The mechanism for a user stimulus may include but is not limited to a button, trigger or switch which is housed on the receiver circuit board 116, as well as features added to a GUI in an embodiment where the receiver assembly 118 is replaced by a smartphone application. In certain embodiments, the receiver is configured to passively receive data collected from the sensor assembly 104 at a predefined interval. In certain embodiments, the sensor 110 is sending data at predefined intervals, and the receiver is stimulated to receive and process that data by a stimulus from the user or application.

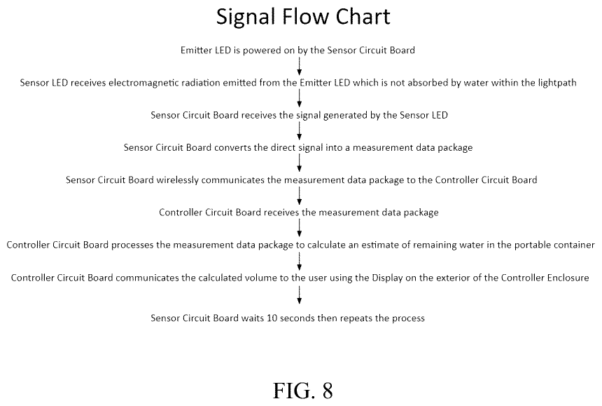

Certain embodiments, as seen in FIG. 8, comprises an emitter 106. The emitter 106 is configured to emit a signal, such as light, acoustic, or electromagnetic radiation signals. In certain embodiments, the emitter 106 utilizes an appropriate wavelength of emission to provide for observable differences corresponding to a change in water volume. In certain embodiments, it has been found that the preferred wavelength of the emitter 106 is 940 nm, as electromagnetic water absorption peaks at ˜950, 1400, and 1700. In certain embodiments, the emitter 106 is placed within the bottom of the container, facing upwards, wherein the direction of the emission is parallel to gravity during the natural positioning of the fluid reservoir 102 while in use, so that as the fluid volume is reduced, the fluid level of the lightpath between the emitter 106 and sensor 110 is proportionally reduced. In certain embodiments, the emitter 106 is kept in place by adhering it to one end of the sensor enclosure 120. In certain embodiments, the emitter 106 is positioned in an aperture in the sensor enclosure 120, with the epoxy case protruding outside of the sensor enclosure 120 within the reservoir, and the anode/cathode leads extending into the interior of the sensor enclosure 120. In an alternative embodiment, the emitter 106 is placed entirely within the sensor enclosure 120. In certain embodiments, the emitter 106 is operably connected to the sensor circuit board 112, and powered by a battery housed on the sensor circuit board 112. In certain embodiments, the emitter 106 is a light-emitting diode (LED). In certain embodiments, the emitter 106 could be configured to produce light from any portion of the electromagnetic spectrum. In certain embodiments, the emitter 106 is configured to produce an acoustic signal. In certain embodiments, the emitter 106 is oriented along a different axis than that of gravity. It will be appreciated by those in the art that the emitter and sensor orientation could be any rotational degree.

Certain embodiments, comprises a sensor 110. In certain embodiments, the sensor 110 consists of an LED configured to receive a signal, typically electromagnetic radiation, acoustic, or light, generating an electric signal as a result, which is received by the sensor circuit board 112. In certain embodiments, the sensor 110 is operably connected to the circuit board housed within the sensor enclosure 120. In certain embodiments, the sensor 110 receives the light from the emitter 106, reflected by the reflective assembly 108, which is not lost to absorption or diffraction. In certain embodiments, the sensor 110 is wired in a configuration that converts the received light into a voltage, which is measured by the sensor circuit board 112. In certain embodiments, the sensor 110 is positioned within the container with the photosensitive end parallel to that of the direction of the emitter 106, wherein, the photosensitive end of the sensor 110 is positioned parallel to gravity during the natural positioning of the fluid reservoir 102 while in use. In certain embodiments, the sensor 110 is positioned in direct proximity to the emitter 106, wherein, the sensor 110 is positioned such that the photosensitive component housed within the epoxy case is protruding out of the sensor enclosure 120, and the anode/cathode leads extend within the interior of the sensor enclosure 120. In certain embodiments, the sensor 110 is kept in position by adherence to the enclosure tube as well as the walls of the sensor enclosure 120. In an alternative embodiment, the sensor 110 is placed entirely within the sensor enclosure 120. In certain embodiments, the sensor 110 could be any light-sensitive device which produces an electronic signal, including but not limited to photodiodes and phototransistors, including any absolute or differential photometer. In certain embodiments, the sensor 110 is represented by an ultrasonic transducer. In certain embodiments, the sensor 110 is oriented along a different axis than that of gravity. In certain embodiments, the sensor 110 is oriented along a different axis than that of the direction of the emitter 106.

Certain embodiments, comprises a sensor circuit board 112. In certain embodiments, the sensor circuit board 112 comprises a microcontroller, a transmitter, and a battery, wherein the microcontroller is defined as any integrated circuit that contains one or more CPUs, memory, and programmable input/output peripherals. In certain embodiments, the microcontroller is operably connected to the battery, the transmitter, the emitter, and the sensor. In certain embodiments, the microcontroller functions as a switch to power on the emitter, and receives a voltage generated by the sensor, wherein the microcontroller acts as an analog-to-digital converter, processing the measured voltage from the sensor to a data package, which is sent to the circuit board housed on the receiver assembly 118 via the transmitter. In an alternative embodiment, the sensor circuit board 112 may be configured to perform the calculation to determine the fluid remaining.

In certain embodiments, as seen in FIG. 8, the method for a predefined periodic loop of measuring events and steps, comprises the following:
1. The microcontroller powers on emitter
2. The microcontroller reads voltage from the sensor
3. The microcontroller cuts power to emitter
4. The microcontroller converts and stores the data in variable on the microcontroller
5. The RF transmitter is initialized by the microcontroller
6. The transmitter sends the voltage measurement in a data packet
7. The microcontroller cuts power to transmitter
8. Wait a predetermined interval
9. Repeat

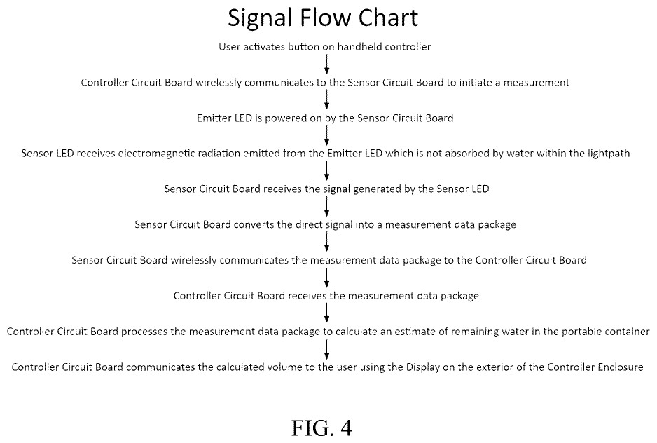

In certain embodiments, as seen in FIG. 4, the method for a user initiated measuring event, comprises the following:
1. User initiates a measuring event using the receiver assembly 118
2. The microcontroller receives a signal from the receiver assembly 118 to initiate a measurement
3. The microcontroller powers on emitter
4. The microcontroller reads voltage from the sensor
5. The microcontroller cuts power to emitter
6. The microcontroller converts and stores the data in variable on the microcontroller
7. Initialize RF transmitter by the microcontroller
8. The transmitter sends the voltage measure data packet
9. The microcontroller cuts power to transmitter
10. The microcontroller enters a standby state, awaiting an initiating signal from the receiver assembly 118.

Certain embodiments, comprises a transmitter, wherein the transmitter is defined as a device housed on a circuit board for the purpose of sending a signal and functions to send a data packet wirelessly to an external receiver, housed on the receiver circuit board 116. In certain embodiments, the transmitter is configured to transmit via 2.4 GHz RF (radio frequency). Certain embodiments may comprise any form of wired or wireless signal transmission including but not limited to Bluetooth, wireless, and AM/FM. In certain embodiments, the transmitter is configured to communicate with the corresponding receiver housed on the receiver circuit board 116.

Certain embodiments, comprises one or more of a sensor circuit board 112, further comprising a battery, which provides power to the microcontroller, transmitter, emitter, and sensor. In certain embodiments, the battery is a silver oxide 1.5 V button battery. Certain embodiments may utilize different cell types, voltage ratings, battery sizes and shapes, or a rechargeable battery. In certain embodiments, the microcontroller initiates a measurement event at a predefined frequency, for example ranging from 10 GHz to once every hour. In certain embodiments, the sensor circuit board 112 includes a receiver element to receive a signal from the receiver assembly, triggering the microcontroller to perform a user-initiated measuring event. In certain embodiments, the sensor circuit board 112 may be separated into multiple circuit boards, housing any combination of the components described above. In certain embodiments, the sensor circuit board(s) 112 may be housed in any location on the sensor assembly 104, or separately from the sensor assembly 104. In certain embodiments, the sensor circuit board 112 may be configured to transmit the data package via a wired connection.

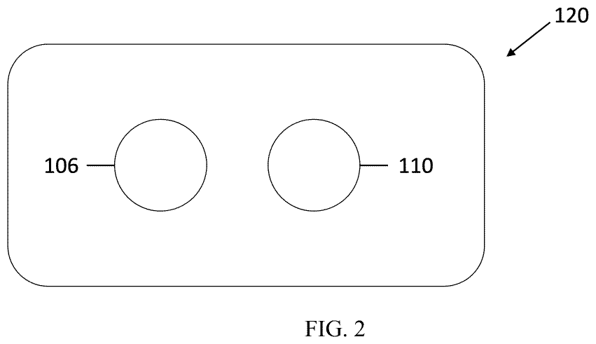

Certain embodiments, as seen in FIG. 2, comprises a sensor enclosure 120. In certain embodiments, the enclosure is configured to house waterproof elements of the system, such as the circuit board and the electronic leads of both the emitter and sensors. In certain embodiments, the sensor enclosure 120 is watertight. In certain embodiments, the sensor enclosure 120 is manufactured of food-grade plastic. In certain embodiments, the dimensions of the sensor enclosure 120 are 3.5 cm×5.5 cm×2 cm. In certain embodiments, the sensor enclosure 120 could be manufactured of any material that is FDA-approved to come in direct contact with water or fluid intended for human consumption. In certain embodiments, the sensor enclosure 120 is manufactured out of a material that is transparent to the signal generated by the emitter 106 and detected by the sensor 110. In certain embodiments, this material is transparent to light in the NIR light spectrum. The size and shape of the sensor enclosure 120 may vary in alternative embodiments. In certain embodiments, the sensor enclosure 120 is secured to the container such that the orientation of the emitter 106 and sensor 110 are parallel to the axis of gravity. The mounting mechanism of the sensor enclosure 120 to the container walls may be, but is not limited to, the use of magnetic positioning, using a secured magnet on the container, as well as a corresponding magnet secured to the sensor enclosure 120. It will be appreciated by those skilled in the art, that the orientation of the sensor enclosure 120, and thus sensor assembly 104, may vary in alternative configurations of the device. In certain embodiments, the sensor assembly 104 may be housed on the interior of the fluid reservoir 102, as well as manufactured into the structure of the reservoir itself.

Certain embodiments, comprises a receiver or receiver assembly 118. In certain embodiments, the receiver may comprise one or more of components comprising a receiver enclosure 114, a circuit board, an indicator display, or optionally a trigger. In certain embodiments, the receiver houses a receiver circuit board 116. In certain embodiments, the receiver circuit board 116 interfaces between the user and the sensor assembly 104 and houses a microcontroller, a receiver, and a battery. In certain embodiments, the microcontroller is defined as any integrated circuit that contains one or more of CPUs, memory, and programmable input/output peripherals. In certain embodiments, the microcontroller is operably connected to the battery, the receiver, and the display. In certain embodiments, the receiver is defined as a device housed on a circuit board to receive a signal and functions to receive a data packet from an external transmitter, housed on the sensor circuit board 112. In certain embodiments, the receiver is configured to receive via 2.4 GHz RF. Certain embodiments may comprise any form of wireless signal transmission including but not limited to Bluetooth, wireless, and AM/FM. In certain embodiments, the display is defined as any electronic indicator that is interpretable by human senses. In certain embodiments, the display is a pair of seven segment displays, which are configured to display numbers to the user to communicate the calculated fluid remaining volume. In certain embodiments, the indicator comprises any of or some combination of LEDs, sonic indicators, digital screens or other display means configured to communicate text and/or numerical results. In certain embodiments, the receiver circuit board 116 measures 12 mm×18 mm×1 mm, and includes the appropriate electronics to perform the functions described above. It will be appreciated by those skilled in the art that the receiver circuit board 116 may comprise a variety of shapes and sizes. In certain embodiments, a direct wired system replaces the wireless communication system, wherein the components of the sensor circuit board 112 and receiver circuit board 116 may be combined into a single circuit board housed either in the receiver assembly 118 or the sensor assembly 104. In certain embodiments, the receiver circuit board 116 may include, but is not limited to, a singular or a collection of OEM products or a custom designed PCB. In certain embodiments, the functions of the receiver are replaced with an application available on any smartphone, wherein, the application would be able to communicate with the sensor circuit board 112, initiating a measurement and receiving a measurement data package, and process the data package received from the sensor assembly 104. In certain embodiments, the mode of communication between the application and the sensor circuit board 112 may include but is not limited to, RF, Bluetooth, wireless, and AM/FM. In certain embodiments, the application would be able to communicate with the user by allowing a measurement to be collected as well as displaying the calculated fluid remaining measurement to the user via a variety of GUI configurations.

In certain embodiments, as seen in FIG. 8, the method for a predefined measurement interval comprises the following steps:
1. Measurement Initiation. Initiating a measurement with the receiver circuit board 116 at a predefined frequency, irrespective of stimulus from the user.
2. Measurement performed/initiated by the sensor microcontroller. Initiating a switch with the microcontroller to allow power to the emitter, while simultaneously, the microcontroller reads the signal generated by the sensor.
3. Wireless transmission of the data packet. The transmitter on the sensor circuit board 112 will send the data packet wirelessly via 2.4 GHz RF to the receiver housed on the receiver circuit board 116.
4. Receive the measurement data packet from the sensor circuit board. The receiver circuit board 116 is operably connected to the sensor circuit board 112. The receiver circuit board 116 will receive the measurement data package from the sensor circuit board 112. In the preferred configuration, this signal will be transmitted wirelessly via 2.4 GHz RF.
5. Calculate water volume using the data package and a predefined formula. The receiver circuit board 116 uses the measured data package to calculate an estimate of the remaining fluid in the fluid reservoir 102. This formula will be based on the current measurement compared to a reference measurement, which will be equal to the measured data package in a condition in which the emitter 106 and sensor 110 are unobstructed by fluid. In the preferred embodiment, the formula will be reestablished by the user. In another configuration, the formula will be predetermined per model version and saved into the receiver circuit board 116 memory permanently.
6. Display the calculated volume to the user and repeat. The receiver circuit board 116 will interface directly with the user by communicating the calculated remaining fluid volume via the pair of seven segment displays. The microcontroller housed on the sensor circuit board 112 waits 10 seconds, then initiates the process at step 1, repeating the process.

In certain embodiments, as seen in FIG. 4, the receiver assembly 118 includes an exterior button accessible to the user and is operably connected to the receiver circuit board 116, a transmitter, and the sensor circuit board 112 which includes a receiver. The method for a user-initiated measurement comprises the following steps:
1. The user activates a measurement using the exterior button. By depressing the exterior button housed on the receiver assembly 118, the microcontroller on the receiver circuit board 116 will activate the transmitter housed on the receiver circuit board 116.
2. Sensor receiver initiated. The receiver housed on the sensor circuit board 112 receives the signal generated by the receiver circuit board transmitter, initiating the sensor circuit board microcontroller to power on and initiate a measurement event.
3. Measurement performed initiated by the sensor microcontroller. The microcontroller will initiate a switch to allow power to the emitter. Simultaneously, the microcontroller will read the signal generated by the sensor.
4. Wireless transmission of the data packet. The transmitter on the sensor circuit board 112 will send the data packet wirelessly via 2.4 GHz RF to the receiver housed on the receiver circuit board 116.
5. Receive the measurement data packet from the sensor circuit board. The receiver circuit board 116 is operably connected to the sensor circuit board 112. The receiver circuit board 116 will receive the measurement data package from the sensor circuit board 112. In the preferred configuration, this signal will be transmitted wirelessly via 2.4 GHz RF.
6. Calculate water volume using the data package and a predefined formula. The receiver circuit board 116 uses the measured data package to calculate an estimate of the remaining fluid in the fluid reservoir 102. This formula will be based on the current measurement compared to a reference measurement, which will be equal to the measured data package in a condition in which the emitter 106 and sensor 110 are unobstructed by fluid. In the preferred embodiment, the formula will be reestablished by the user. In another configuration, the formula will be predetermined per model version and saved into the receiver circuit board memory permanently.
7. Display the calculated volume to the user. The receiver circuit board 116 will interface directly with the user by communicating the calculated remaining fluid volume via the pair of seven segment displays.

In certain embodiments, as seen in FIGS. 4 & 6, the method the sensor assembly 104 calculates the remaining fluid in the container comprises the following:
1. The emitter receives power from the battery housed on the sensor circuit board 112, generating 950 nm light emission.
2. The epoxy case of the emitter directs the light in the direction opposite of the anode/cathode leads.
3. Light emission diverges throughout the volume of the container.
4. As the light emission travels through air, very little energy is absorbed.
5. As the radiation travels through water, observable amounts of energy are absorbed.
6. The light is contained by the reflective assembly 108, which redirects the light back into the cavity of the container, eventually reaching the position of the sensor 110.
7. Photons are collected by the sensor 110 and converted into a direct voltage signal.
8. The sensor-generated voltage is measured by the microprocessor housed on the sensor circuit board 112.
9. The measurement data package is wirelessly transmitted to the microprocessor housed on the receiver circuit board 116.
10. The microprocessor housed on the receiver circuit board 116 utilizes the measurement data package to calculate the remaining fluid.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are claimed, it should be understood that compounds known and available in the art prior to Applicant's invention, including compounds for which an enabling disclosure is provided in the references cited herein, are not intended to be included in any composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

The terms “first,” second,” “top,” “bottom,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. Further, “Providing” an article or apparatus, as used herein, refers broadly to making the article available or accessible for future actions to be performed on the article, and does not connote that the party providing the article has manufactured, produced, or supplied the article or that the party providing the article has ownership or control of the article.

One of ordinary skill in the art will appreciate the art within the drawings and can employ various alterations to the design within those presented. The drawings are exemplary of a design and are illustrative of the invention but should not be construed to create limitations of the invention. The invention in the drawings suitably may be practiced in variations without departure from the spirit of the invention.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A system for the measurement of fluid levels within a reservoir, comprising:
a fluid reservoir;
a reflective assembly;
a sensor assembly;
and a receiver assembly.

2. The fluid reservoir of claim 1, wherein said fluid reservoir comprises flexible walls.

3. The fluid reservoir of claim 1, wherein said fluid reservoir comprises rigid walls.

4. The reflective assembly of claim 1, wherein said reflective assembly encloses at least a portion of the interior of the fluid reservoir.

5. The reflective assembly of claim 4, wherein said reflective assembly is removably connected.

6. The reflective assembly of claim 4, wherein said reflective assembly is fixedly connected.

7. The reflective assembly of claim 1, wherein said reflective assembly encapsulates at least a portion of the exterior of the fluid reservoir.

8. The reflective assembly of claim 7, wherein said reflective assembly is removably connected.

9. The reflective assembly of claim 7, wherein said reflective assembly is fixedly connected.

10. The sensor assembly of claim 1, wherein said sensor assembly is located within the interior of the fluid reservoir.

11. The sensor assembly of claim 1, wherein said sensor assembly is located within the interior of the fluid reservoir.

12. The sensor assembly of claim 1, wherein said sensor assembly comprises an emitter, a sensor, a sensor circuit board, and a sensor enclosure.

13. The emitter of claim 12, wherein said emitter comprises an LED, configured to emit a signal.

14. The sensor of claim 12, wherein said sensor comprises an LED, configured to receive a signal.

15. The receiver assembly of claim 1, wherein the receiver assembly communicates with the sensor assembly.
